(19) United States
(12) Patent Application Publication
(10) Pub. No.: US 2009/0070164 A1
(43) Pub. Date: Mar. 12, 2009

(54) REAL TIME SELF ADJUSTING TEST PROCESS

(75) Inventors: Ivory W. Knipfer, Rochester, MN (US); Kurt D. Knodel, Rochester, MN (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/854,115

(22) Filed: Sep. 12, 2007

(51) Int. Cl. G06F 17/50; G05B 13/02; G06F 9/44

(52) U.S. Cl. 705/7; 700/33; 700/28

(57) ABSTRACT

Embodiments of the present invention address deficiencies of the art in respect to test processing manufactured products and provide a method, system and computer program product for self-adjusting test processing of manufactured goods in a supply chain management data processing system. In an embodiment of the invention, a method for real time self adjusting testing of products in a supply chain manufacturing operation can be provided. The method can include associating different products with optional test activities as part of one or more risk groups. Thereafter, a production order can be evaluated to identify a product, to match one or more of the risk groups to the product, and to omit associated ones of the optional test activities in the matched risk groups from a production process for the production order.

### BACKGROUND OF THE INVENTION

1. Field of the Invention

The present invention relates to the field of supply chain management and more particularly to test processing manufactured products in a supply chain management data processing system.

2. Description of the Related Art

As the global economy provides a proliferation of options for businesses to expand into emerging markets, manufacturing success increasingly can be defined by how fast one acts and how well one reacts to supply chain volatility. Modern production facilities increasingly are becoming more complex as customers expect manufacturers to maintain low prices while readily accommodating last-minute changes in quantity, product configuration or delivery date. Thus, effectively managing the timing, order policy, and supply and inventory considerations involved in new product introductions or upgrades, greatly impact cycle times, potential business opportunities, and most importantly sales and profits.

With respect to technology oriented products, test processing manufactured products can be of paramount importance to ensure product quality and reliability and to avoid significant manufacturing problems like recall. Typically for manufactured technology products the test process can be divided into two phases. In a first phase, minimum testing is provided in order to meet only the product test and acceptance specification. In a more intense, albeit optional follow-on phase, additional testing can be provided, when time and capacity allow. The second phase can be valuable to the manufacturer of the product in order to validate the sufficiency of the first phase of testing, the piloting of new test algorithms, the detecting of time independent intermittent errors, and the collecting of soft error rate data. Ideally the optional testing is done in its entirety on every product manufactured.

During peak production times, manufacturers struggle to meet customer shipments and revenue cutoffs. As a result, often it can be necessary to skip some or all of the optional tests of the second phase in a controlled fashion to improve throughput without compromising customer quality expectations. Automated solutions for controlling when to skip the second phase of optional testing operate on simple logic—namely the current date. For example, the simple logic can require that all optional tests are skipped on the last day of the fiscal quarter, or on the scheduled ship date. Consequently, the decision of when to test in the second phase and when to skip the testing of the second phase must be made in advance and not on an individual product basis.

Manual intervention for controlling when to skip the second phase of optional testing, by comparison, involves addressing each individual product. To that end, skilled resources are required and the process of manual intervention can be both labor intensive and also error prone. Manual intervention yet further requires analysis to select which products require intervention and when to intervene. Expert skills are required to perform this analysis, and those expert skills are the same skills required to support production. Using expert skills for projections, however, drives inefficiency in manufacturing.

The automated and manual solutions both result either in exposures to resource utilization, customer shipments, and revenue attainment, or to performing optional testing on far fewer products then necessary. When optional activities are skipped on more products than necessary there is a loss in performance data and the value of performing the optional tests in the first place.

### BRIEF SUMMARY OF THE INVENTION

Embodiments of the present invention address deficiencies of the art in respect to test processing manufactured products and provide a novel and non-obvious method, system and computer program product for self-adjusting test processing of manufactured goods in a supply chain management data processing system. In an embodiment of the invention, a method for real time self adjusting testing of products in a supply chain manufacturing operation can be provided. The method can include associating different products with optional test activities in a plurality of corresponding risk groups, evaluating a production order to identify a corresponding product, matching individual ones of the risk groups to the corresponding product, and omitting associated ones of the optional test activities in the matched individual ones of the risk groups from a production process for the production order.

In one aspect of the embodiment, the method further can include establishing a cutoff time for each production order for applying the risk groups to the production order and triggering the evaluating and matching responsive to an estimated time to completion for the production order exceeding the cutoff time. In another aspect of the embodiment, triggering the evaluating and matching responsive to an estimated time to completion for the production order exceeding the cutoff time can include updating an estimated time of completion for the production order, and, in response to detecting an update to the estimated time of completion for the production order, triggering the evaluating and matching. Finally, in yet another aspect of the embodiment, evaluating a production order to identify a corresponding product can include loading a set of production orders in the supply chain management operation, and filtering the set of production orders to a subset according to filtering criteria selected from the group consisting of order type, product, product number, production status, order priority and ship date/build date.

In another embodiment of the invention, a supply chain management data processing system can be provided. The system can include manufacturing data including production orders and risk groups defined for different products and associated optional test activities. The system also can include real-time self-adjusting test process logic. The logic can include program code enabled to evaluate a production order to identify a corresponding product, to match individual ones of the risk groups to the corresponding product, and to omit associated ones of the optional test activities in the matched individual ones of the risk groups from a production process for the production order. Notably, each of the risk groups can include a product list of products and a list of optional test activities to be skipped when producing a production order for the products in the product list. Optionally, each of the risk groups further can include a list of product numbers each corresponding to one of the products in the product list.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a real time self adjusting testing process for supply chain management;

FIG. 2 is a schematic illustration of a supply chain management data processing system configured for a real time self adjusting testing process;

FIG. 3 is a flow chart illustrating a process for real time self adjusting testing of products in a supply chain manufacturing operation; and,

FIG. 4 is a flow chart illustrating a process for applying risk groups to orders during the real time self adjusting testing of products of FIG. 3.

### DETAILED DESCRIPTION OF THE INVENTION

Embodiments of the present invention provide a method, system and computer program product for a real time self adjusting testing process. In accordance with an embodiment of the present invention, risk groups can be defined for different products in order to specify test activities considered required and those able to be skipped in order to meet production deadlines. The risk groups can be defined on a product by product basis according to historical performance data and product test and acceptance specifications. Once defined, the risk groups can be applied on a product order-by-order basis in order to dynamically determine whether individually scheduled test activities are to be skipped or applied in order to meet production deadlines established for the orders. Furthermore, the completion time for individual ones of the orders can be considered when determining whether or not to apply the risk groups to the orders.

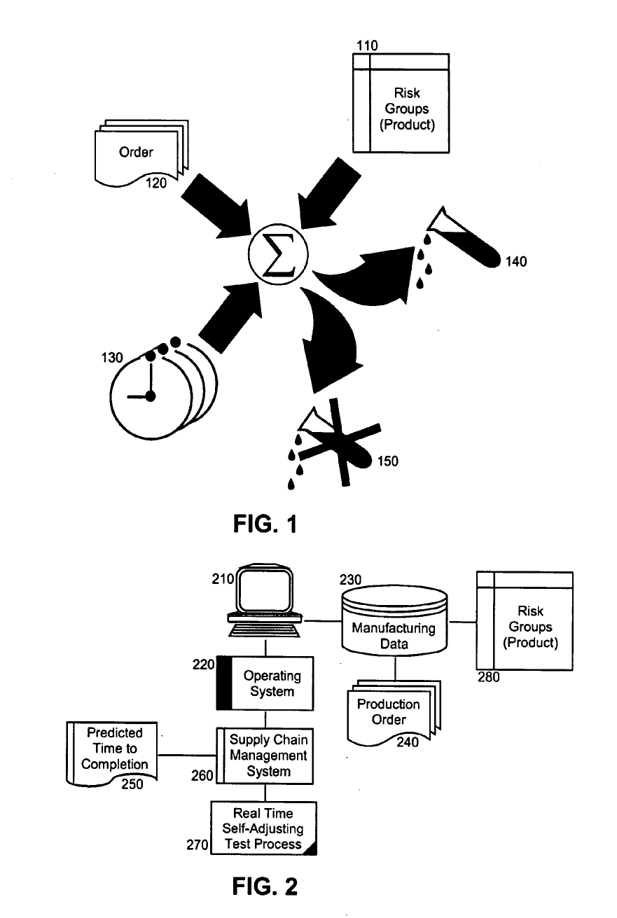

In illustration, FIG. 1 pictorial depicts a real time self adjusting testing process for supply chain management. As shown in FIG. 1, risk groups 110 can be defined for different products in a manufacturing environment. The risk groups 110 can define one or more test activities that can be omitted under different manufacturing scenarios. In this regard, each entry in the risk groups 110 can specify for a test activity a description of the test activity, a corresponding risk level, and criteria which when met calls for the omission of the performance of the test activity. Of course, multiple entries can be specified for a single test activity in view of the possibility that multiple manufacturing scenarios can arise in response to which the test activity is to be skipped. The risk groups 110 can be applied to individual orders 120 to determine on an order-by-order basis whether to route a performance 140 of an optional test activity, or whether to route an omission 150 of the optional test activity.

Additionally, one or more cutoff times 130 also can be specified for different products. The cutoff times 130 indicate a moment, or range of time in a manufacturing process subsequent to which it is no longer feasible to allow the performance 150 of test activities of an optional nature. Rather, subsequent to the cutoff times 130 for respective ones of the products a reduction in optional testing is desired as a target shipment date approaches. Thus, not only can optional test activities be omitted or performed strategically according to the risk groups 110, but also the cutoff times 130 provide an optimized consideration of the risk groups 110 and avoid needless performance of optional test activities when it is no longer feasible to perform optional test activities.

The real time self adjusting testing process for supply chain management of FIG. 1 can be performed in an automated supply chain management data processing system. To that end, FIG. 2 is a schematic illustration of a supply chain management data processing system configured for a real time self adjusting testing process. The system can include a host computing platform 210 including an operating system 220. The operating system 220 can support the operation of a supply chain management system 260 configured to access manufacturing data 230, including one or more production orders 240 for one or more products.

Predicted time to completion logic 250 further can be coupled to the supply chain management system 260. The predicted time to completion logic 250 can be configured to predict a time to completion for an order based upon a current state of manufacturing for the order and the historically observed times to completion for similar orders. Finally, a real-time self-adjusting test process 270 can be coupled to the supply chain management system 260. The real-time self-adjusting test process 270 can include program code enabled to determine which optional test activities are to be performed for individual ones of the production orders 240 and which optional test activities are to be omitted for individual ones of the production orders 240 based upon the application of one or more risk groups 280 to individual ones of the production orders 240.

In this regard, the risk groups 280 can be applied to define related groups of optional test activities to enable the controlled reduction of manufacturing test activities to be applied to products in real-time. Each of the risk groups 280 can include a grouping identifier, a listing of one or more affected products, a description of associated risks and optional testing activity reductions, a list of part numbers, a list of optional testing activities listed for omission, a window of time during which the optional testing activity reductions can be applied to orders in process for the affected products, and a flag indicating whether or not the risk groups for the record is to be activated for application. With particular respect to the part numbers, an order can be excluded from the skipping of an optional test activity where the order does not include a particular part specified by part number. Conversely, an order can be excluded from the skipping of an optional test activity where the order does include a particular part specified by part number.

Once the risk groups 280 have been defined, the different production orders 240 can be compared to the risk groups 280 to determine whether or not to omit performance of one or more optional test activities for products implicated by the different production orders 240, presuming that the production orders 240 fall within a permissible time frame. Furthermore, the predicted time to completion 250 for the different production orders 240 can vary and can be compared to the permissible time frame in order to determine whether or not a corresponding one of the risk groups 280 can be applied to the production orders 240. Finally, different ones of the production orders 240 can be filtered to limit the application of the risk groups 280 to only selected ones of the production orders 240. In particular, the production orders 240 can be filtered by order type, product, product number, production status, order priority, part number content, ship date or build date.

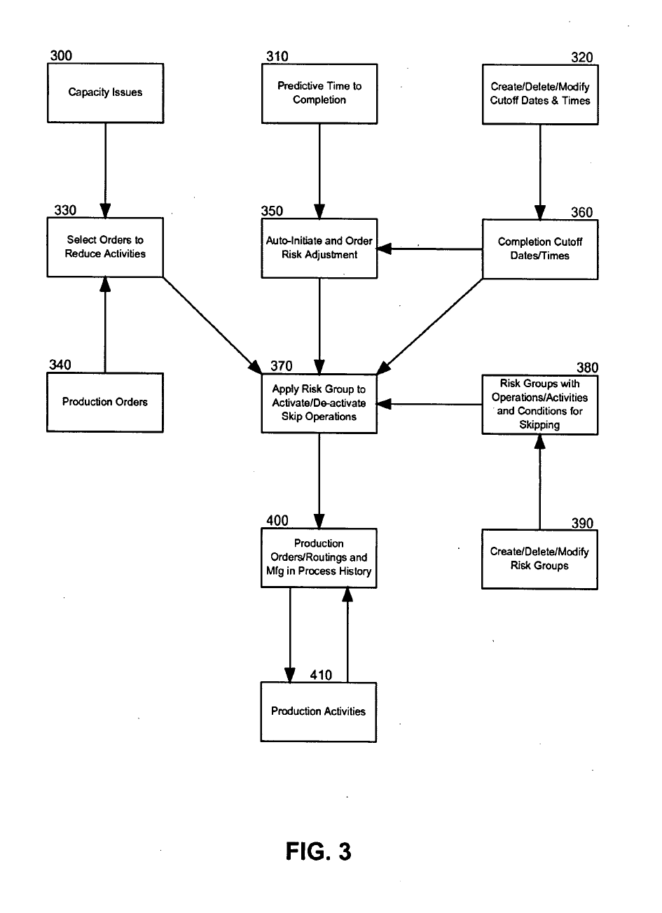

In even yet further illustration, FIG. 3 is a flow chart illustrating a process for real time self adjusting testing of products in a supply chain manufacturing operation. In block 300, capacity issues in the manufacturing process can be identified such as the current run rate over the capacity of production to determine which production orders to be selected through filtering for application by risk groups. In block 340 production orders can be loaded and in block 330, the loaded production orders can be filtered to a subset. In block 390, one or more risk groups can be created, deleted or modified and in block 380, the risk groups can be matched to individual production orders on an order by order basis. Thereafter, in block 370 the risk groups can be applied to the filtered subset in order to activate or deactivate different optional test activities for the productions orders in the subset.

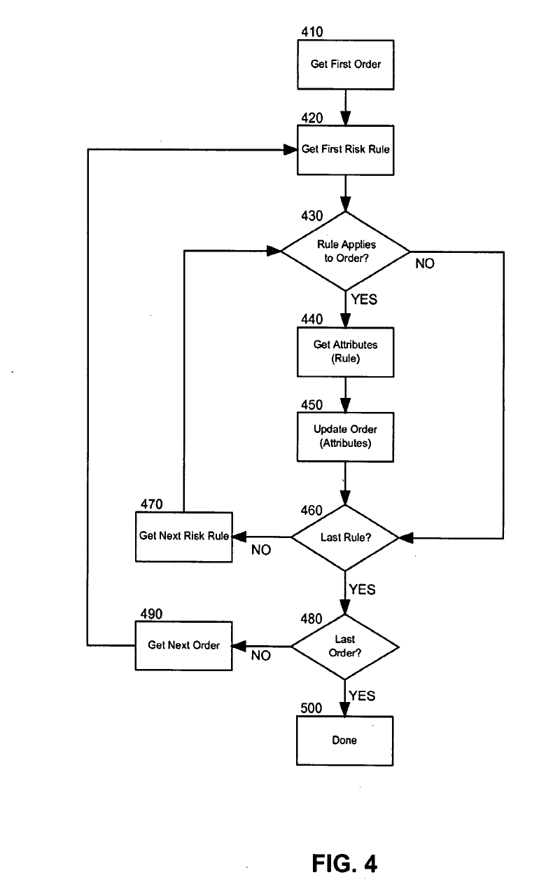

In more particular illustration, FIG. 4 is a flow chart illustrating a process for applying risk groups to a filtered subset of orders during real time self adjusting testing of products. Beginning in block 410, a first order can be selected and in block 420, a first risk rule can be further selected. In decision block 430, it can be determined whether or not the risk rule applies to the order. If so, in block 440 the attributes for the rule can be retrieved and in block 450, the order can be updated with the attributes. Thereafter, in decision block 460 it can be determined if additional rules remain to be processed. If so, a next rule can be retrieved in block 470 and the process can repeat through block 430. When all rules have been processed, in decision block 480 it can be determined if additional orders remain to be processed. If so, in block 490 a next order can be retrieved and the process can repeat through block 420. Otherwise, the process can end in block 500.

Returning now to FIG. 3, in block 320, one or more cutoff times can be managed including the creation, deletion or modification of a window of time during which application of risk groups for an order in production is appropriate and outside of which the application of risk groups is not permitted. In block 360, the cutoff times (and dates where defined) can be applied to the determination of whether or not one or more risk groups are to be applied to one or more production orders for one or more products. In this regard, in block 310, a predictive time to completion can be determined for one or more production orders and in block 350, it can be determined whether or not to automatically initiate a risk adjustment to the production orders based upon both the estimated time to completion and the completion cutoff dates/times for the different production orders.

The predicted time to completion for an order can trigger the evaluation of cutoff entries for the order whenever the predicted time to completion for an order is updated. Once triggered, if the predicted time to completion falls outside of the cutoff window, in block 370 the risk groups can be applied to the order to determine whether or not a reduction in optional test activities can be applied by omitting one or more optional test activities from the production process for the order. Thereafter, in block 400 the orders can be processed to execute in block 410 only those optional test activities that have not been selected for omission. For optional test activities that have been omitted, a log can be maintained to identify the skipped optional test activities on an order by order basis.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for real time self adjusting testing of products in a supply chain manufacturing operation, the method comprising:
associating different products with optional test activities in a plurality of corresponding risk groups;
evaluating a production order to identify a corresponding product;
matching individual ones of the risk groups to the corresponding product; and,
omitting associated ones of the optional test activities in the matched individual ones of the risk groups from a production process for the production order.

2. The method of claim 1, further comprising:
establishing a cutoff time for each production order for applying the risk groups to the production order; and,
triggering the evaluating and matching responsive to an estimated time to completion for the production order exceeding the cutoff time.

3. The method of claim 2, wherein triggering the evaluating and matching responsive to an estimated time to completion for the production order exceeding the cutoff time, comprises:
updating an estimated time of completion for the production order; and,
responsive to detecting an update to the estimated time of completion for the production order, triggering the evaluating and matching.

4. The method of claim 1, wherein evaluating a production order to identify a corresponding product, comprises:
loading a set of production orders in the supply chain management operation; and,
filtering the set of production orders to a subset according to filtering criteria selected from the group consisting of order type, product, product number, production status, order priority and ship date/build date.

5. A supply chain management data processing system comprising:
manufacturing data comprising a plurality of production orders and risk groups defined for different products and associated optional test activities; and,
real-time self-adjusting test process logic comprising program code enabled to evaluate a production order to identify a corresponding product, to match individual ones of the risk groups to the corresponding product, and to omit associated ones of the optional test activities in the matched individual ones of the risk groups from a production process for the production order.

6. The system of claim 5, wherein each of the risk groups comprise:
a product list of products; and,
a list of optional test activities to be skipped when producing a production order for the products in the product list.

7. The system of claim 6, wherein each of the risk groups further comprise a list of product numbers each corresponding to one of the products in the product list.

8. The system of claim 5, further comprising:
a plurality of cutoff times each corresponding to a different product; and,
predicted time to completion logic configured to indicate a predicted time to completion for different products, the program code of the real-time self-adjusting test process logic being further enabled to initiate a reduction in optional test activities for the production order in response to an update to a predicted time to completion for the production order.

9. A computer program product comprising a computer usable medium embodying computer usable program code for real time self adjusting testing of products in a supply chain manufacturing operation, the computer program product comprising:
computer usable program code for associating different products with optional test activities in a plurality of corresponding risk groups;
computer usable program code for evaluating a production order to identify a corresponding product;
computer usable program code for matching individual ones of the risk groups to the corresponding product; and,
computer usable program code for omitting associated ones of the optional test activities in the matched individual ones of the risk groups from a production process for the production order.

10. The computer program product of claim 9, further comprising:
computer usable program code for establishing a cutoff time for each production order for applying the risk groups to the production order; and,
computer usable program code for triggering the evaluating and matching responsive to an estimated time to completion for the production order exceeding the cutoff time.

11. The computer program product of claim 10, wherein the computer usable program code for triggering the evaluating and matching responsive to an estimated time to completion for the production order exceeding the cutoff time, comprises:
computer usable program code for updating an estimated time of completion for the production order; and,
computer usable program code for, in response to detecting an update to the estimated time of completion for the production order, triggering the evaluating and matching.

12. The computer program product of claim 9, wherein the computer usable program code for evaluating a production order to identify a corresponding product, comprises:
computer usable program code for loading a set of production orders in the supply chain management operation; and,
computer usable program code for filtering the set of production orders to a subset according to filtering criteria selected from the group consisting of order type, product, product number, production status, order priority and ship date/build date.
